(19) United States
(12) Patent Application Publication
(10) Pub. No.: US 2020/0198482 A1
(43) Pub. Date: Jun. 25, 2020

(54) GENERATOR USING APPLIED ENVIRONMENTAL MOTIONS

(71) Applicant: John T. McAnallan, San Anselmo, CA (US)

(72) Inventor: John T. McAnallan, San Anselmo, CA (US)

(21) Appl. No.: 16/720,560

(22) Filed: Dec. 19, 2019

Related U.S. Application Data
(60) Provisional application No. 62/782,607, filed on Dec. 20, 2018.

(51) Int. Cl. B60L 53/12; H02K 7/18; H02K 35/02

(52) U.S. Cl. CPC B60L 53/12; H02K 35/02; H02K 7/1876

(57) ABSTRACT

The present invention utilizes artful mechanisms to translate movement into electricity. Embodiments of the invention may also include the use of radially wound induction coil, having advantages over the prior art use of vertically wound embodiments. Disclosed embodiments are capable of using all movements of a vehicle such as the bounce of a vertical movement or a horizontal movement. A disclosed embodiment may be placed in various positions within or upon a vehicle. Further, disclosed embodiments may be used in any vehicle, but are very well suited for electric vehicles as the disclosed embodiments may power parasitic equipment of a vehicle.

### CROSS-REFERENCE TO RELATED APPLICATIONS

The present application claims priority to U.S. Provisional Patent Application Ser. No. 62/782,607, filed on Dec. 20, 2019 entitled “Generator Using Applied Environmental Motions”, the disclosure of which is hereby incorporated in its entirety at least by reference.

### BACKGROUND OF THE INVENTION

### 1. Field of the Invention

The invention generally relates to mechanical systems that generate electricity, more particularly, the invention relates to means and methods of creating electricity from environmental movements, such as those found in vehicles and other devices or environments.

### 2. Description of Related Art

The known related art fails to anticipate or disclose the principles of the present invention. Thus, there is a need in the art for the present invention.

### BRIEF SUMMARY OF THE INVENTION

The following presents a simplified summary of some embodiments of invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present invention provides an unobvious and unique combination and configuration of methods and components to produce electricity by capturing or using motion found in a vehicle such as suspension bounce, sway bar movement and other vehicle motions. The present invention utilizes artful mechanisms to translate movement into electricity. Embodiments of the invention may also include the use of radially wound induction coil, having advantages over the prior art use of vertically wound embodiments. Disclosed embodiments are capable of using all movements of a vehicle such as the bounce of a vertical movement or a horizontal movement. A disclosed embodiment may be placed in various positions within or upon a vehicle. Further, disclosed embodiments may be used in any vehicle, but are very well suited for electric vehicles as the disclosed embodiments may power parasitic equipment of a vehicle.

In order to do so, in one aspect of the present invention, a generator is provided, comprising an induction coil; a main shaft configured to stroke linearly; a magnet attached to the main shaft, wherein the magnet via the main shaft is configured to travel longitudinally through the induction coil to generate electricity; a support element configured to support the induction coil and guide the magnet; an outer housing configured to cover and protect at least the induction component coil; and, wherein the generator is installed in a vehicle to provide the generated electricity to a rechargeable battery from the vehicle's environmental motions.

In another aspect of the invention, a system is provided, comprising a vehicle having a suspension system configured to receive at least one shock absorber, the vehicle subjected to environmental movement; a rechargeable battery; at least one generator configured to generate electricity from the environmental movement to charge the rechargeable battery, the at least one generator comprising: an induction coil; a main shaft configured to stroke linearly; a magnet attached to the main shaft, wherein the magnet via the main shaft is configured to travel longitudinally through the induction coil to generate electricity; a support element configured to support the induction coil and guide the magnet; an outer housing configured to cover and protect at least the induction component coil; and, wherein the at least one generator is configured to replace the at least one shock absorber.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is an exploded view illustrating components of a generator using applied environmental motions according to an embodiment of the present invention.

FIG. 2 is a sectional view illustrating the generator using applied environmental motions according to an embodiment of the present invention.

FIG. 3 depicts exemplary installation locations for the generator in a vehicle according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a generator using applied environmental motions.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words “a” or “an”, or other words using the singular or plural number also include the plural or singular number, respectively. Additionally, the words “herein,” “above,” “below,” and words of similar import, when used in this application, shall refer to this application as a whole and not to any particular portions of this application

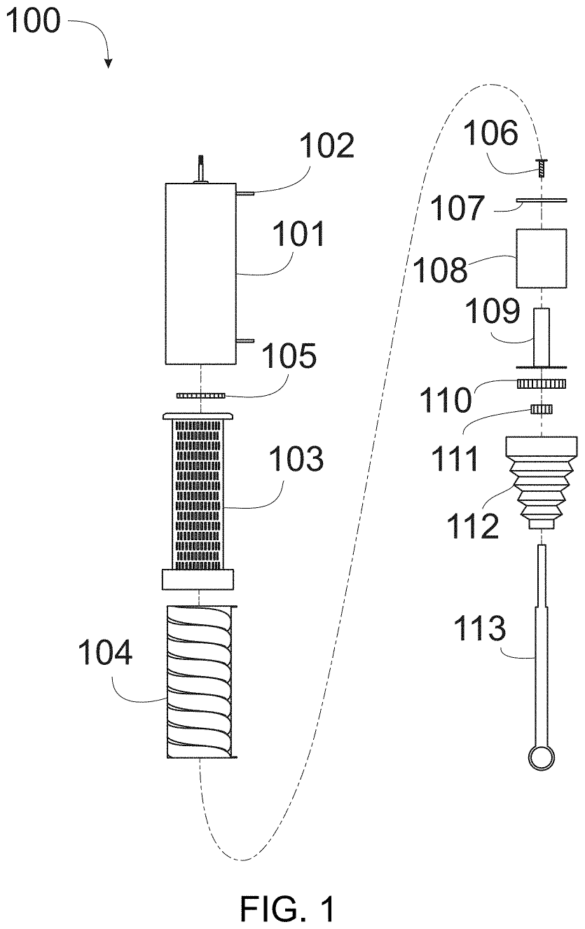

FIG. 1 depicts an exploded view of a disclosed generator 100. Referring now to FIG. 1, the generator 100 comprises an outer housing 101 configured to cover and protect internal components and mechanisms. In some embodiments, a strain relief and seal 102 may take the form of two components. The strain relief and seal is configured to protect radially wound induction coil(s) 104 wire from damage as well as sealing the coil lead wire as the wire exits one or more voids provided on the housing 101.

The generator comprises a support element 103 retained within the outer housing 101. Advantageously, the support element 103 is a multifunctional component. In some embodiments, the support element 103 comprises a support structure for the induction coil 104. Further, the support element 103 acts as a guide for a magnet 108 and as a locator for elastomeric bumper 105 at the inside of the top end of the outer housing 101. While shown in an assembled state as one part, it comprises two parts to aid in assembly.

The elastomeric bumper 105 may be disposed inside the top of the outer housing 101 to protect the magnet 108 from contact with the outer housing 101 during the up stroke cycle of the generator.

In some embodiments, a screw 106 or fastener may hold the magnet 108 to a main shaft 113 of the generator by retaining a hold down clamp 107 in position upon the main shaft 113. In some embodiments, the hold down clamp 107 may have multiple uses and act as a magnetic/electric insulator that retains the magnet 108 from contacting the hold down screw 106 and the main shaft 113. Also if the hold down clamp 107 contacts the bumper 105 it will protect the magnet 108 from impact damage.

In some embodiments, the magnet 108 may comprise either a permanent magnet or electro-magnet that may be disposed or mounted on the main shaft 113 by use of insulators and be moved longitudinally through the induction coils 104 to generate electricity.

In some embodiments, an insulator 109 is configured to mount the magnet 108 to the main shaft 113. Further, the insulator is configured to shield the magnetic field from grounded out through the main shaft.

In some embodiments, a second elastomeric bumper 110 is configured to be fitted to the bottom or interior end of the generator to protect the magnet 108 on the down stroke of the generator from any contact damage.

In some embodiments, a sealed linear bearing or alignment member 111 provides tracking and/or alignment and a secondary seal for the main shaft 113.

In some embodiment, a flexible boot type seal 112 is configured to be used to keep foreign material out of the internal area of the generator. The main shaft 113 of the generator retains, aligns and moves the magnet 108 though a cycle, the cycle powered by the up and down motion imparted by the vehicle, such as the suspension system as the vehicle moves.

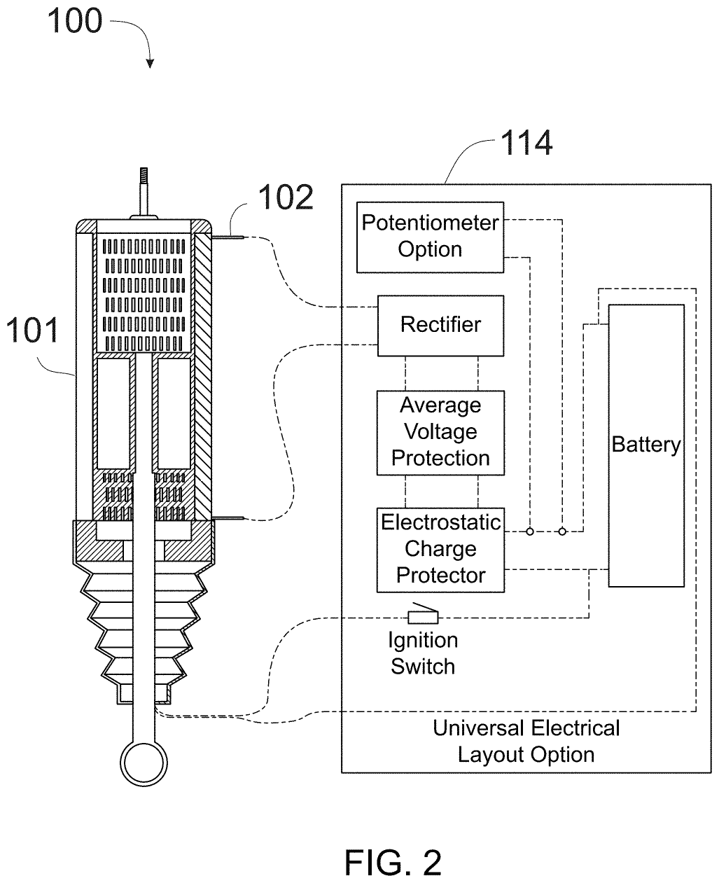

FIG. 2 depicts a sectional view of the generator 100 along with an electrical layout 114. The generator is configured to apply the environmental motions, such as in a vehicle as previously mentioned, to translate mechanical (linear) motion/energy into electrical energy via electromagnetic induction. The electrical layout shows the various components configured to take the electrical energy created via the generator to charge a battery. Advantageously, if the generator is installed in an electric vehicle, the generator may contribute to increased range utilizing normal vehicle motion from suspension, sway bar movement, etc. In traditional combustion engines, the one or more generators can supply power to the rechargeable battery to help power various electric components in addition to the vehicle's alternator.

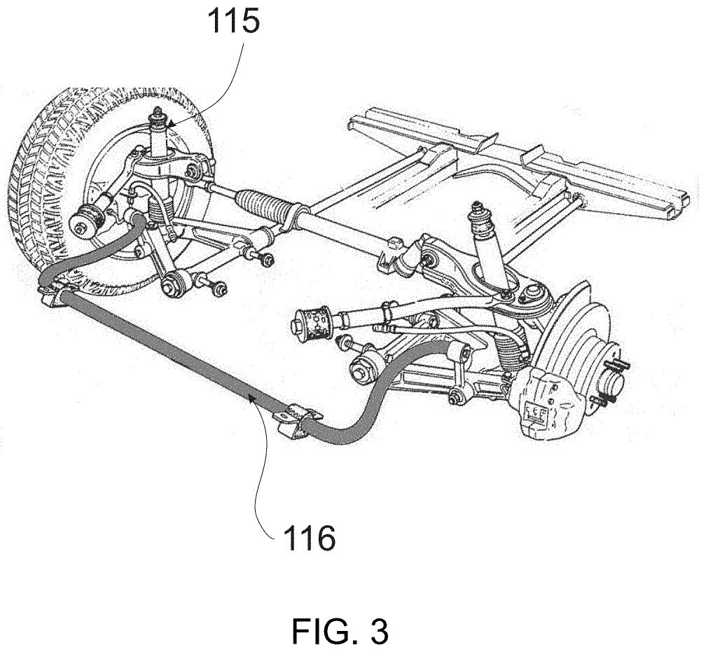

FIG. 3 depicts exemplary installation locations for the generator 100 in a vehicle. In some embodiments, the generator 100 may be installed in the vehicle's suspension 115, sway bar 116, or another location on the vehicle permitting natural movement, such as the vertical bounce of the suspension, or horizontal sway of the sway bar or anti-roll bar. It should be understood that multiple generators may be installed in the vehicle to generator more electrical energy. In some embodiments, one or more generators may be used to replace components of the vehicle. For instance, in some embodiments, one or more generators 100 may act as the vehicle's suspension and either replace the traditional suspension (shock absorbers) or be in additional to other shock absorbers for each corner of the vehicle. That is, in situations where only one shock absorber is provided near a vehicle's wheel, the generator may replace and act as a shock absorber. Advantageously, the stiffness of the suspension is adjustable via the potentiometer, i.e. the energy at which the one or more generators produce may be adjusted. As energy is extracted from the generator, the harder it is for the main shaft 113 to travel (up and down stroke). The amount at which the energy is extracted may be adjusted via the potentiometer. The more energy extracted the stiffer the suspension would become.

Shock absorbers and the generator positioned and installed to replace one or more shock absorbers is advantageously, as both stop cyclic vibration as the vehicle travels in various road conditions keeping the tires in contact with the road surface while providing a good ride experience for the vehicle's passengers.

In addition to replacing one or more shock absorbers in a vehicle, one or more generators may be installed in conjunction with a vehicle's sway bar taking advantage of the movement of vehicle components to create electrical energy. Although a vehicle's shock absorbers and sway bar are used as examples, any vehicle component subjected to natural motion can be replaced with a generator 100 or used in conjunction with a generator 100 to produce electricity. In these instances, the one or more generators may produce energy for the vehicle even when the vehicle is stationary and moves due to environmental conditions, including but not limited to wind, vehicles and trucks passing closely causing the vehicle to sway, etc.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention. For instance, although the disclosed generator is preferred to be installed in a vehicle, other applications may be realized without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

### REFERENCE LIST

101 Outer Housing

102 Strain And Relief Seal

103 Support Element

104 Induction Coil

105 Elastomeric Bumper

106 Fastener

107 Clamp And Insulator

108 Magnet

109 Insulator

110 Second Elastomeric Bumper

111 Alignment Member

112 Flexible Boot Type Seal

113 Main Shaft

114 Electrical Layout

115 Shock Absorber

116 Sway Bar

What is claimed is:

1. A generator comprising:
an induction coil;
a main shaft configured to stroke linearly;
a magnet attached to the main shaft, wherein the magnet via the main shaft is configured to travel longitudinally through the induction coil to generate electricity;
a support element configured to support the induction coil and guide the magnet;
an outer housing configured to cover and protect at least the induction component coil; and,
wherein the generator is installed in a vehicle to provide the generated electricity to a rechargeable battery from the vehicle's environmental motions.

2. The generator of claim 1, further comprising a first elastomeric bumper positioned inside a top inside portion of the outer hosing above a top outer portion of the support element, wherein the first elastomeric bumper is configured to protect the magnet from contact with the outer housing during an up stroke cycle of the generator.

3. The generator of claim 1, further comprising a second elastomeric bumper positioned inside a bottom inside portion of the outer hosing, wherein the second elastomeric bumper is configured to protect the magnet from contact with the outer housing during a down stroke cycle of the generator.

4. The generator of claim 1, wherein the magnet is attached to the main shaft via an insulating clamp and a fastener respectively.

5. The generator of claim 2, wherein the insulating clamp is configured to prevent the magnet from contacting the fastener.

6. The generator of claim 1, wherein the generator is configured to replace or be in addition to the vehicle's one or more shock absorbers.

7. The generator of claim 1, wherein the generator is configured to be installed in conjunction with the vehicle's sway bar.

8. The generator of claim 1, wherein the induction coil is a radially wound induction coil.

9. A system comprising:
a vehicle having a suspension system configured to receive at least one shock absorber, the vehicle subjected to environmental movement;
a rechargeable battery;
at least one generator configured to generate electricity from the environmental movement to charge the rechargeable battery, the at least one generator comprising:
an induction coil;
a main shaft configured to stroke linearly;
a magnet attached to the main shaft, wherein the magnet via the main shaft is configured to travel longitudinally through the induction coil to generate electricity;
a support element configured to support the induction coil and guide the magnet;
an outer housing configured to cover and protect at least the induction component coil; and,
wherein the at least one generator is configured to replace the at least one shock absorber.

10. The system of claim 9, wherein the at least one generator as a replacement of the at least one shock absorber has a variable stiffness.

11. The system of claim 10, further comprising a potentiometer configured to vary the generated electricity of the generator such that the variable stiffness may be controlled.
